(19) United States
(12) Patent Application Publication
(10) Pub. No.: US 2022/0343248 A1
(43) Pub. Date: Oct. 27, 2022

(54) SYSTEMS AND METHODS OF PREDICTING ESTIMATED TIMES OF ARRIVAL BASED ON HISTORICAL INFORMATION

(71) Applicant: GoBrands, Inc., Philadelphia, PA (US)

(72) Inventors: Patrick Niklaus, Berlin (DE); Max Bennedich, Kerrville, TX (US); Sowmya Yellapragada, Berlin (DE)

(73) Assignee: GoBrands, Inc., Philadelphia, PA (US)

(21) Appl. No.: 17/729,152

(22) Filed: Apr. 26, 2022

Related U.S. Application Data
(60) Provisional application No. 63/179,650, filed on Apr. 26, 2021.

(51) Int. Cl. G06Q 10/06; G06Q 10/04; G06Q 50/30; G08G 1/00; G08G 1/01

(52) U.S. Cl. CPC G06Q 10/06315; G06Q 10/047; G06Q 50/30; G08G 1/202; G08G 1/0129; G08G 1/0112

(57) ABSTRACT

A method is performed at a system hosting a first dispatching service. The method includes receiving historical information that includes information for a plurality of trips made by a fleet of vehicles. The plurality of trips were dispatched by a second dispatching service, and the information includes an actual time of arrival for each of the plurality of trips. The method also includes, for each trip of the plurality of trips: predicting an estimated time of arrival using services provided by the first dispatching service and computing a difference between the estimated time of arrival and the actual time of arrival for the trip. The method further includes generating a statistical model based on the computed differences, receiving a trip request, and dispatching a vehicle for the trip request using the services provided by the first dispatching service and based at least in part on the statistical model.

### TECHNICAL FIELD

The disclosed embodiments relate generally to systems and methods for routing and providing estimated times of arrival based on historical information.

### BACKGROUND

In the coming years, autonomous vehicle (AV) technology will overcome the present challenges in motion planning and control. For example, autonomous vehicles will be able to stay in lanes, follow cars, avoid pedestrians and drive like a taxi driver patrolling the streets. Autonomous vehicles will need only to be told where to go and how to get there, making route planning critical in the AV-driven world.

As developers build core autonomy technology and start to scale their fleets of vehicles for ride-sharing fleets, ride-hailing fleets, and/or delivery fleets, these developers will need effective dispatch and fleet management technology. The winners and losers in this race will be determined by which companies operate the most efficient fleets with the highest vehicle utilization.

### SUMMARY

Efficient dispatching of vehicles is important in operation and management of a fleet of vehicles for providing on-demand transportation. Efficient and effective dispatching can lead to reduced wait times for passengers, high vehicle utilization rates, and an overall increase in user and driver satisfaction. Vehicles are dispatched based on expected vehicle availability, which may require predicting which vehicles will be available at a given time (e.g., a future time). During periods of high demand, a prediction of vehicle availability may depend on the ability to accurately predict trip completion times (or times of arrival).

Although the present disclosure is not limited to on-boarding of a new fleet of vehicles to a routing/dispatching service, such on-boarding does present a particular challenge for the routing service's ability to predict trip completion times or times of arrival at a destination because the routing service has not yet had the opportunity to adjust its routing model to the particularities of the fleet of vehicles. To address this problem, in some embodiments, a computer system associated with a routing/dispatching service determines estimated trip completion times or estimated arrival times (ETAs) for a plurality of trips that were previously completed by the fleet of vehicles. The determined trip completion times or ETAs, as determined by the routing and/or dispatching service, are compared against actual trip completion times or actual arrival times to generate a statistical model. The statistical model is used to update and improve ETA prediction for the fleet of vehicles that are routed and/or dispatched by the routing and/or dispatching service.

To that end, in accordance with some embodiments, a method is performed at a system hosting a first fleet dispatching service (e.g., dispatch service) for one or more fleets of vehicles. The method includes receiving historical route data (e.g., historical information) that includes information for a plurality of trips made by a fleet of vehicles, including an actual time of arrival for each trip of the plurality of tips. The method also includes, for each trip of the plurality of trips, predicting an ETA based on conditions at a time of the trip using services provided by the first fleet dispatching service, and computing a difference between the ETA and the actual time of arrival for the trip. The method further includes generating a statistical model based on the computed differences, receiving a first trip request for a first trip, and dispatching a first vehicle for the first trip request, using the services provided by the first fleet dispatching service, based at least in part on the statistical model.

Some embodiments of the present disclosure provide a computer system (e.g., a server system), comprising one or more processors and memory storing one or more programs. The one or more programs store instructions that, when executed by the one or more processors, cause the computer system to perform any of the methods described herein.

Some embodiments of the present disclosure provide a non-transitory computer readable storage medium storing instructions that, when executed by a computer system having one or more processors, cause the computer system to perform any of the methods described herein.

These embodiments improve prediction of estimated arrival time (or trip completion time). Thus, such embodiments may improve overall operation and management for the fleet of vehicles by improving the efficiency of vehicle dispatching and increasing vehicle utilization rates.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1A illustrates a timeline for a vehicle completing a trip, in accordance with some embodiments.

FIG. 1B illustrates timelines for vehicles of a fleet completing a plurality of trips, in accordance with some embodiments.

FIGS. 2A-2B illustrate examples of historical information, in accordance with some embodiments.

FIGS. 3A-3C illustrate an example of generating an estimated time of arrival for a trip based on historical information, in accordance with some embodiments.

FIGS. 4A-4C illustrate another example of generating an estimated time of arrival for a trip based on historical information, in accordance with some embodiments.

FIGS. 5A-5B are block diagrams illustrating an architecture of a vehicle routing engine, in accordance with some embodiments.

FIG. 6 is a block diagram illustrating a client-server environment, in accordance with some embodiments.

FIGS. 7A-7D illustrate a flowchart of a method for predicting estimated times of arrival based on historical information, in accordance with some embodiments.

### DETAILED DESCRIPTION

The systems and methods described herein improve prediction of estimated times of arrival (ETAs) (or trip completion times) for vehicles (including AVs) of a fleet by using historical information (e.g., historical data) that includes information regarding a plurality of trips that were previously completed by vehicles of the fleet of vehicles.

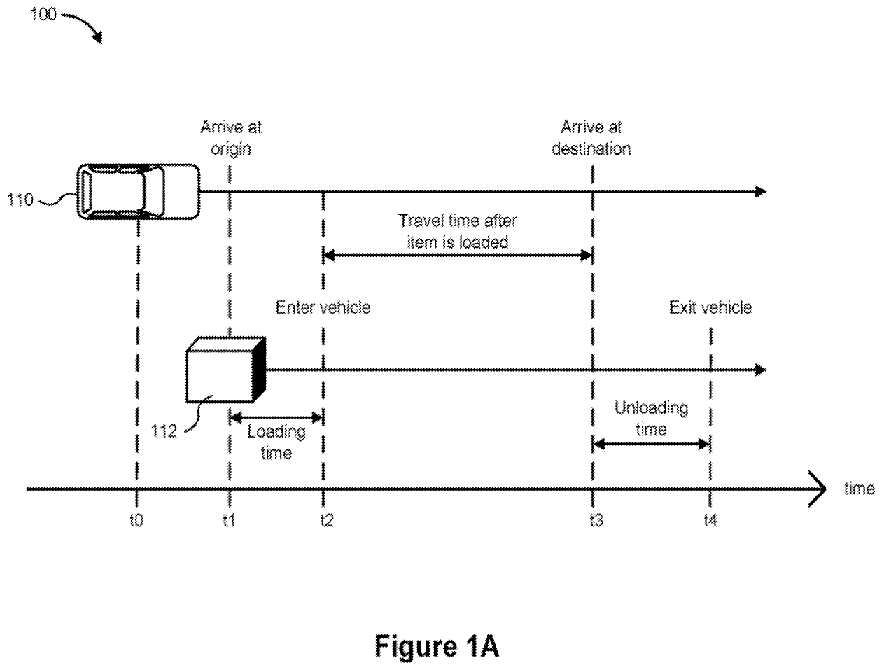

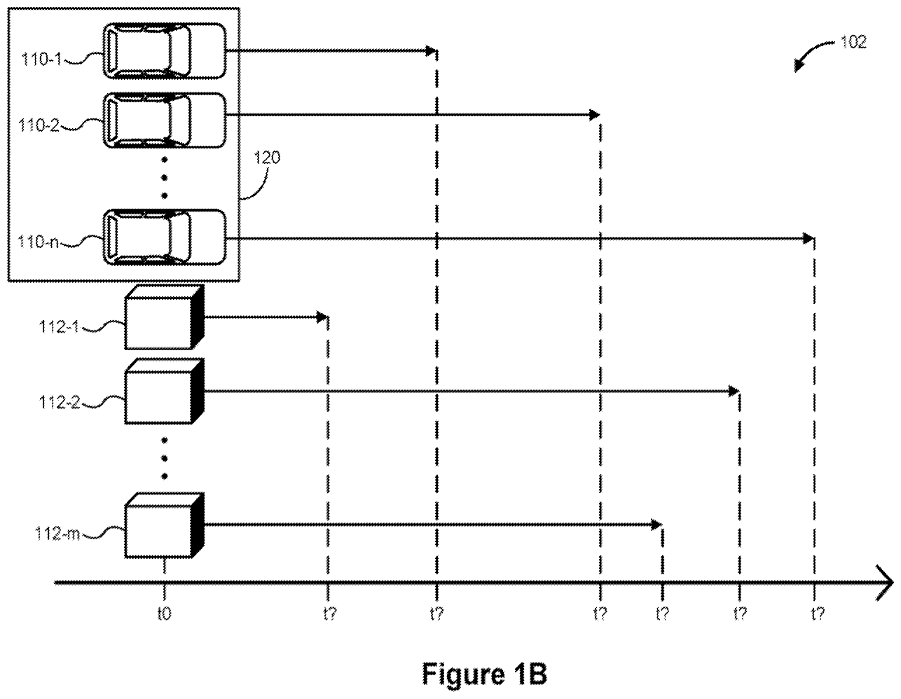

FIG. 1A illustrates a timeline 100 for a trip that is completed by a vehicle 110, in accordance with some embodiments. Vehicle 110 starts a trip at time t0 when the vehicle is assigned to the trip by a dispatching service (e.g., dispatch engine). At time t1, the vehicle 110 arrives at the origin (e.g., pick-up location) of the trip, and cargo 112 (e.g., passenger(s) or package(s)) loading onto vehicle 110 is completed at time t2 (e.g., all passengers have entered the vehicle 110, all packages are securely packed onto the vehicle 110). The vehicle 110 arrives at the destination (e.g., drop-off location) at time t3, and unloading of the cargo 112 is completed at time t4 (e.g., all passengers have exited the vehicle 110, all packages are removed from the vehicle 110). In some embodiments, time t4 also corresponds to a trip completion time (e.g., a time at which the vehicle 110 is considered to be available to start a new trip).

Timeline 100 is an example of a general timeline for a given trip. Most trips share the time markers (t0 to t4) as described above. In some embodiments, in order to complete a trip, a vehicle 110 may include additional steps or may omit one or more steps shown in timeline 100. For example, a vehicle 110 may be delivering item(s) that are currently available (e.g., stored) on the vehicle 110. In such cases, the vehicle may be able to complete the trip without having to arrive at an origin and having to load the item(s). In another example, the vehicle 110 may be part of a fleet of vehicles that have a cleaning requirement between each trip. Thus, the timeline for trips completed by vehicle 110 may include an additional cleaning step after time t4 (e.g., after unloading is completed) before the vehicle 110 can be considered to have completed the trip and be available to start a new trip.

In general, it is desirable to be able to generate an accurate estimated trip completion time for each trip that is completed by a vehicle of a fleet of vehicles. In some embodiments, generating an estimated trip completion time for a trip requires generating accurate times for tasks or steps within the trip. For example, in order to provide an accurate trip completion time t4 for the trip represented by timeline 100, accurate predictions of travel time to the origin, loading time, travel time, and unloading time are required.

Without historical information from previous trips that have been completed by vehicles of the fleet, it may be challenging for the fleet manager or dispatching service to accurately provide an estimated tip completion time (or to provide estimated times for any of the steps within the trip). For example, loading and unloading times may vary based on the cargo type or quantity of cargo 112 that is being loaded onto the vehicle (e.g., loading one passenger versus loading four passengers, or loading passengers versus packages). In another example, loading times (which include wait times for passengers to arrive at the vehicle 110 after the vehicle 110 has arrived at the origin) may vary based on time of day (e.g., morning versus afternoon) or may vary based on origin location (e.g., airport versus urban area versus suburban neighborhood). In yet another example, travel times may vary from driver to driver based on their driving habits (e.g., a first driver of the fleet is a fast driver and trips completed by the first driver generally have an actual arrival time that is faster than the estimated time of arrival). Moreover, the effect that these factors have on trip completion times may vary from one fleet of vehicles to the next in unpredictable ways, based on particularities of the fleets of vehicles. Thus, having historical information regarding trips previously completed by the fleet of vehicles can be very helpful in providing accurate trip completion times (and accurate task completion times).

FIG. 18 illustrates timelines 102 for a plurality of trips that are completed by vehicles 110 of a fleet 120 of vehicles, in accordance with some embodiments. The fleet 120 of vehicles includes a plurality of vehicles 110-1, 110-2, . . . 110-n that are dispatched to complete a trip or available to be assigned to a new trip (e.g., a new trip request). Thus, successful management of the fleet 120 requires accurate prediction of the expected availability of the vehicles 110 at a given time (e.g., a future time). For example, if all vehicles 110 of the fleet 120 are currently unavailable (due to being inactive or currently in progress of completing a trip) when a new trip request is received, a dispatching service for the fleet 120 needs to determine the expected times at which each vehicle 110 of the fleet 120 will be available to complete the new trip request. An accurate prediction of expected vehicle availability for active vehicles of the fleet 120 (e.g., vehicles that are currently completing trips or available for trips) allows the dispatching service to efficiently assign a vehicle to the new trip request, maximize vehicle utilization, and reduce (e.g., minimize) wait time for a user who requested the new trip. Additionally, accurate prediction of trip completion times corresponds to accurate ETAs for each trip (e.g., estimated delivery time or unload completion time of cargo 112-1 to 112-m, each corresponding to a different trip). The ability to provide an accurate ETA of the cargo 112 for each trip leads to increased user satisfaction with the transportation service. Thus, in order to provide efficient vehicle dispatching and accurate ETAs to users, the example provided in FIG. 1A for predicting the ETA and/or trip completion time for a single trip is scaled up to include all vehicles 110 and all trips that are completed or in progress by a vehicle 110 of the fleet 120. Thus, the use of historical information regarding trips that have previously been completed by vehicles 110 of the fleet 120 can greatly improve vehicle dispatch efficiency, increase user satisfaction, increase vehicle utilization rate, and improve overall management and operation of the fleet 120 of vehicles 110.

In some embodiments, a first dispatching service dispatches vehicles 110 from the fleet of vehicles 120 in response to trip requests, and the historical information includes information regarding trips completed by vehicles 110 of the fleet 120 that were dispatched by a second dispatching service that is different from (e.g., distinct from) the first dispatching service. For example, when a first dispatching service starts providing a dispatching service for a fleet of vehicles, the first dispatching service may utilize historical information regarding trips completed by the fleet of vehicles that were dispatched by a different dispatching service to improve ETA prediction for the fleet of vehicles. By doing so, the first dispatching service can provide accurate ETAs for the fleet of vehicles starting from the very first trip of the fleet that is dispatched by the first dispatching service.

In some embodiments, the first dispatching service dispatches vehicles 110 from the fleet of vehicles 120 in response to trip requests, and the historical information includes information regarding trips completed by vehicles 110 of the fleet 120 that were dispatched by the first dispatching service. For example, the first dispatching service may use historical information regarding trips completed by the fleet to continually improve ETA prediction for the fleet. Changes to the fleet, such as the introduction of new drivers or changing operational constraints (e.g., routing constraints) over time, can affect ETA prediction. By periodically updating ETA prediction of the first dispatching service based on historical information (e.g., completed trips over the past month), the first dispatching service can continue to update and evolve with changes to the fleet over time.

In order to improve ETA prediction, a dispatching service can generate an ETA (e.g. retrospectively) for each of the trips that were completed by the fleet based on historical information and compute a difference between the ETA and an actual time of arrival from the historical information for each of the completed trips. A statistical model can be generated based on the computed differences and the statistical model can be used to update ETA prediction for the fleet (e.g. for future trips). This process is agnostic as to which fleet dispatching service is used to dispatch and route the vehicles and can be repeated as often and/or as many times as needed. However, in order to generate ETAs for the completed trips that are relevant, it is important that conditions at the time of the completed trip be taken into consideration when generating the ETA. For example, conditions at the time of the completed trip may include any of: a road network at the time of the trip (e.g., what the roads look like, map of the roads), road and traffic conditions at the time of the trip (e.g., construction, road closures), and user-defined constraints at the time of the trip (e.g., operational region of the fleet, prohibited maneuvers, prohibited roads). To that end, in some embodiments, a state of the dispatching and routing system is logged (e.g., the routing conditions are stored) at each time, so that it possible to recreate the state of the dispatching and routing system when performing retrospective ETA prediction.

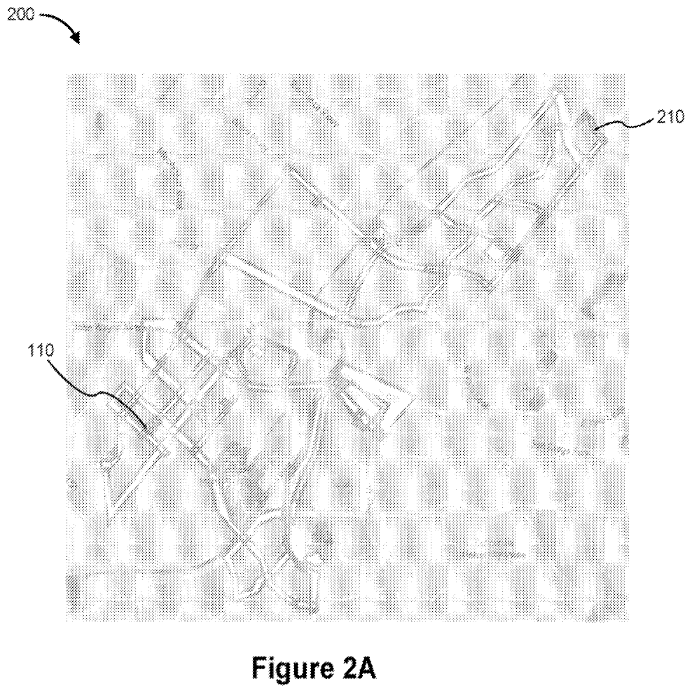

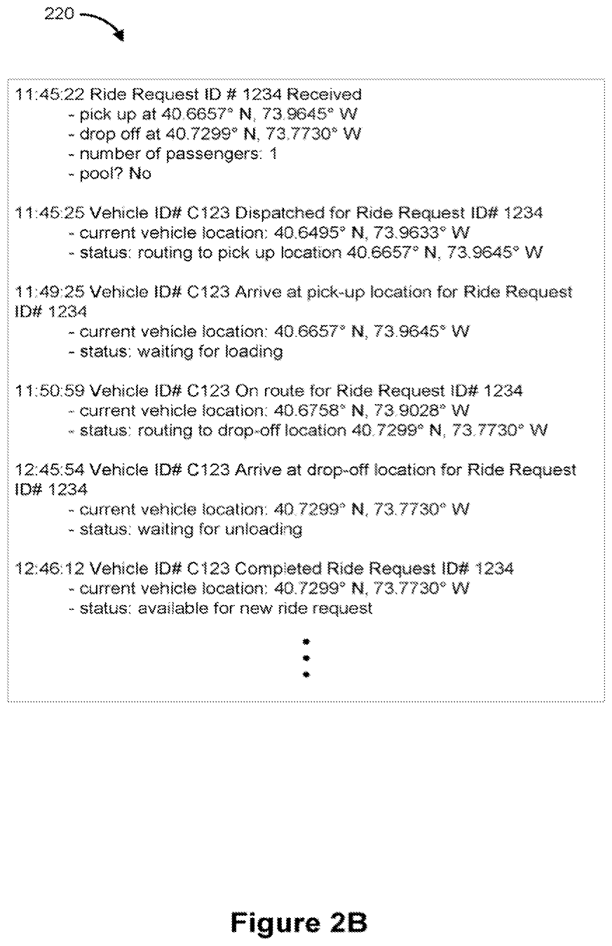

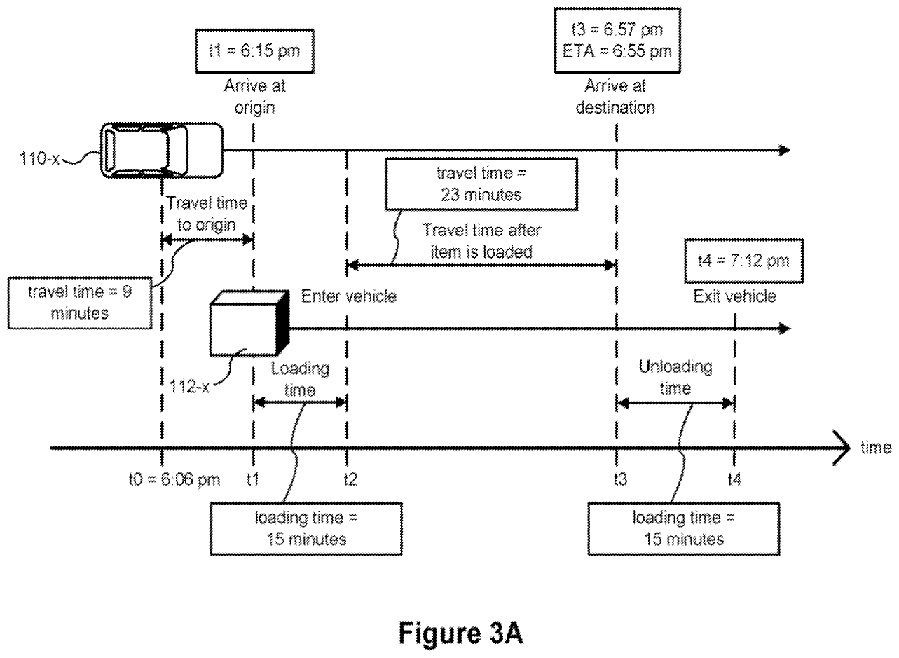

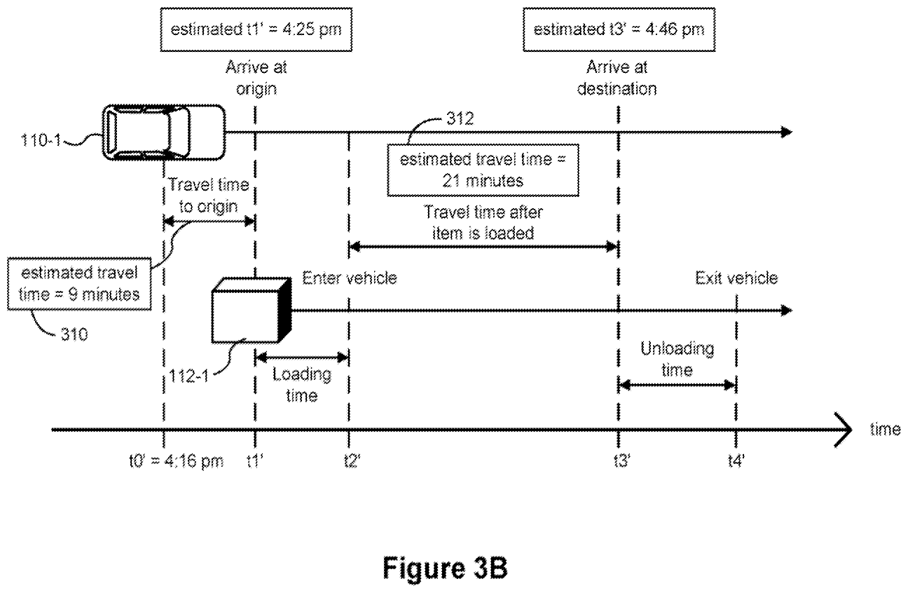

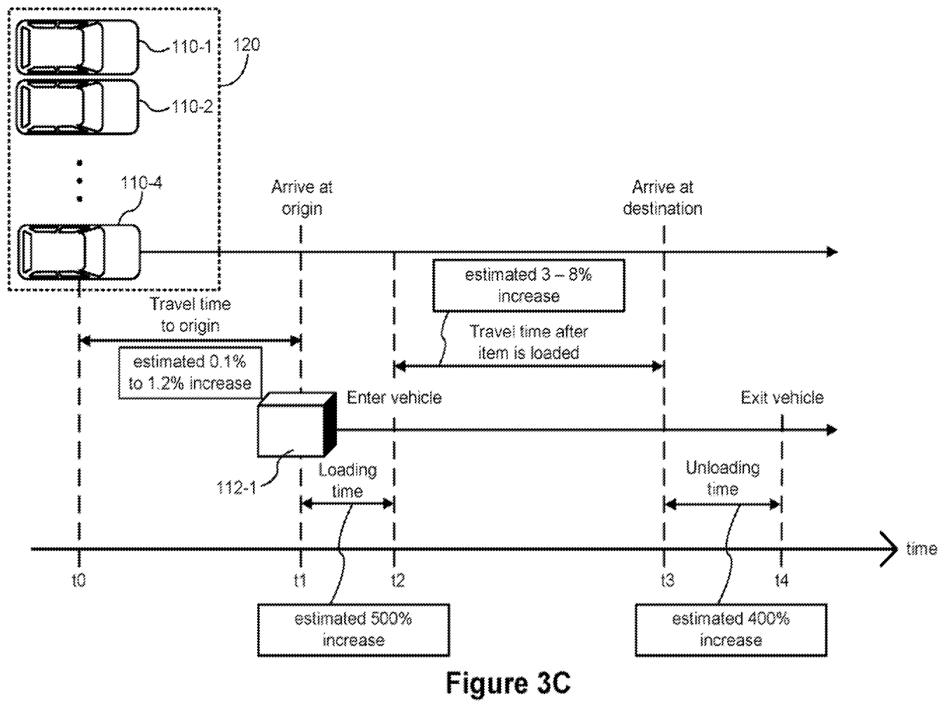

Additional details regarding historical information are provided below with respect to FIGS. 2A-2B. Additional details regarding generating a statistical model based on historical information and providing updated ETAs based at least in part on the statistical model are provided with respect to FIGS. 3A-3C.

FIGS. 2A-2B illustrate examples of historical information, in accordance with some embodiments.

Referring to FIG. 2A, map 200 illustrates route(s) 210 (e.g., roads) taken by a vehicle 110 over a defined period of time (e.g., over all time, over the last month, on weekend days over the last year). In some embodiments, as shown, the map 200 includes historical information for a specific vehicle (such as vehicle 110) of a fleet 120 of vehicles. In some embodiments, the map 200 includes historical information for a fleet 120 of vehicles, which may or may not be a mixed fleet (e.g., having different types of vehicles such as sedans, trucks, autonomous vehicles, non-autonomous vehicles, and/or delivery robots; or having only one type of vehicle, such as only delivery trucks) in some embodiments, a first dispatching service that is configured to dispatch vehicles and/or determine ETAs receives the historical information for a plurality of trips completed by a fleet 120 of vehicles from a second dispatching service that is different from the first dispatching service. The first dispatching service may, for example, receive the historical information for a plurality of trips completed by a fleet 120 of vehicles from a fleet manager of the fleet 120 of vehicles. In some embodiments, the historical information received by the first dispatching service includes information regarding trips that were completed by the fleet 120 of vehicles that were dispatched by the first dispatching service (e.g., the first dispatching service retrieves historical information stored within a computer system associated with the first dispatching service).

In some embodiments, historical information regarding trips completed by vehicle(s) of a fleet 120 of vehicles may be provided as an event log. The event log includes information regarding a pick-up location (e.g., origin), a drop off location (e.g., destination), the trip time (e.g., time of the trip request, time the trip was assigned to a vehicle, time a vehicle was dispatched for the trip, a trip duration), and an actual arrival time (or trip duration). An event log may include varying levels of detail. In some embodiments, the event log (e.g., a detailed event log, a comprehensive event log) includes exact pick up and drop off locations (e.g., street address or GPS coordinates), and example of which is provided with respect to FIG. 28.

FIG. 2B shows an event log 220 that includes details regarding completed trips. The event log 220 includes, for each completed trip: an origin (e.g., pick-up location), a destination (e.g., drop-off location), a time corresponding to the trip (e.g., a trip request time, a vehicle dispatch time, a time at which the trip occurs), and an arrival time (e.g., an actual arrival time). The event log 220 may also include any of: a ride request identifier (e.g., identification (ID) number), a vehicle location at various time stamps during the trip, a trip status, and a vehicle status. In this example, the event log 220 provides detailed information regarding the completed trip. The event log 220 includes a timestamp associated with each task for the completed trip (e.g., receiving a ride request, dispatching a vehicle for the trip, arriving at the pick-up location), as well as details corresponding to the trip and/or task. For example, the event log 220 shows that ride request ID #1234 is received at 11:45:22 and that the trip request is for transporting a single passenger from 40.6657° N, 73.9645° W to 40.7299° N, 73.7730° W. The event log 220 also indicates that this trip request is for a ride-hail trip (not a ride-share or ride-pool trip). The event log 220 also shows that vehicle ID #C123 is dispatched at 11:45:25, as well as a location of the vehicle at the dispatched time (e.g., at 11:45:25) and a status of the vehicle (e.g., en route to the pick-up location). The event log 220 also includes a time of arrival at the destination (e.g., actual time of arrival of the vehicle at the destination). The event log 220 includes such information for a plurality of completed trips.

Historical information, such as event log 220, can be used by a fleet dispatching service to improve the performance of the fleet dispatching service. For example, the fleet dispatching service can compare a predicted time of arrival to an actual time of arrival for completed trips in order to update and improve ETA prediction of the fleet dispatching service.

FIGS. 3A-3C illustrate an example of generating a statistical model based on historical information and generating updated ETAs based on the statistical model, in accordance with some embodiments.

FIG. 3A represents a timeline for a trip that has been completed by a vehicle of the fleet 120 of vehicles. The trip is one of the plurality of trips that are included in historical information used to generate a statistical model for providing updated ETAs to improve ETA prediction accuracy. Thus, the timeline shown in FIG. 3A is only one of a plurality of trips that are used to generate the statistical model.

In order for a dispatching service to provide an ETA for a completed trip, details regarding the completed trip that is obtained from the historical information are required to generate the ETA. For example, information regarding a time of the completed trip (e.g., time of trip request, time of vehicle dispatch for the trip), trip origin, trip destination, and conditions at the trip time are used to recreate conditions for generating the ETA for the completed trip. For example, the ETA for a completed trip is generated based on conditions (e.g., map of roadways and road network, traffic conditions including construction and road closures) at the time of the trip, user-defined constraints of the fleet (e.g., constraints for the fleet as defined by a fleet manager of the fleet) at the time of the trip, and details of the completed trip (e.g., trip origin and trip destination).

In this example, a vehicle 110-x of the fleet 120 of vehicles is dispatched at t0=6:06 pm to complete a requested trip. The vehicle 110-x takes 9 minutes to arrive at the origin, and arrives at the origin at t1 of 6:15 pm. It takes 15 minutes to load the package(s) 112-x and the vehicle departs the origin at time t2. The vehicle 110-x takes 23 minutes to travel to the destination, and arrives at the destination at t3=6:57 pm. The vehicle 110-x takes 15 minutes to unload the package(s) 112-x from the vehicle 110-x and the trip is completed at t4=7:12 pm. In this example, the actual arrival time is 6:57 pm and corresponds to t3 and the ETA is 6:55 pm.

A difference between the ETA and an actual arrival time of the completed trip is determined (e.g., calculated, computed) based on a comparison of the ETA to the actual arrival time of the completed trip. The difference in ETA and actual arrival time is determined for the plurality of completed trips and a statistical model is generated and can be used to update the ETA prediction for the dispatching service. In some embodiments, the statistical model is a linear regression.

FIG. 3B represents a timeline for a trip request that is received from a user. A first dispatching service dispatches vehicle 110-1 of a fleet 120 of vehicles to complete the trip. The vehicle 110-1 is dispatched at t1′ 4:16 pm and the first dispatching service estimates a travel time 310 of 9 minutes and that the vehicle 110-1 will arrive at the origin at an estimated time t1′ of 4:25 pm. The first dispatching service may also estimate a loading time to load the package(s) 112-1 so that the vehicle 110-1 is predicted to depart from the origin (e.g., pick-up location) at a time, t2′. The first dispatching service estimates a travel time 312 of 21 minutes and predicts that the vehicle 110-1 will arrive at the destination (e.g., drop-off location) at an ETA t3′ of 4:46 pm to deliver the package(s) 112-1. The first dispatching service may also estimate an unloading time so that the trip is considered to be completed at a time, t4′.

The estimated times t1′, t2′, t3′, and t4′ correspond to estimated times that are generated by the first dispatching service without taking into consideration historical information. However, to take into consideration historical information of trips completed by the fleet of vehicles 120, as well as any particular characteristics regarding the fleet 120 that may affect arrival times, the estimated times t1′, t2′, t3′, and t4′ need to be updated based on the statistical model generated based on historical information for the fleet 120.

For example, the timeline shown in FIG. 3B may correspond to a trip request that is to be completed by a fleet of delivery vans that is dispatched by the first dispatching service. Thus, the historical information may consist of information for trips that were completed by vans (e.g., not including trips completed by other vehicle types) or trips that were for package delivery (e.g., not including trips for passenger transport).

In some embodiments, the historical information includes information regarding completed trips that were dispatched by a second dispatching service that is different from the first dispatching service. In some embodiments the historical information includes information regarding completed trips that were dispatched by the first dispatching service,

FIG. 3C represents an updated timeline for a plurality of trip requests that are to be completed by the fleet 120 of vehicles (e.g., the fleet of delivery vans). The first dispatching service utilizes a statistical model generated using the historical information shown in FIG. 3A to provide ETAs with improved accuracy. For example, while travel time may vary due to varying travel distances (e.g., distances between an origin and a destination and/or distances between current vehicle location and origin) for each trip, the statistical model allows the first dispatching service to take into account a difference in travel time between a loaded delivery truck and a different type of vehicle or an unloaded delivery truck. In another example, the statistical model allows the first dispatching service to take into account a difference in travel time between an estimated travel time and an expected travel time for a specific driver. For instance, historical information regarding trips completed by a specific driver may indicate that travel times for the specific driver are shorter than the estimated travel time (e.g., the specific driver is a fast driver). In yet another example, the statistical model allows the first dispatching service to take into account a difference in loading and/or unloading time for package delivery relative to passenger transport. Thus, the statistical model can be used by the first dispatching service to improve ETA predictions. For example, the statistical model may include an indication that an estimated travel time from a current vehicle position to a pick up location may take 0.1% to 1.2% longer relative to current estimates by the first dispatching service, an indication that an estimated loading time may take 500% longer relative to current estimates by the first dispatching service (for example, if the first dispatching service is currently providing loading time estimates based on passenger loading). The statistical model may also include an indication that an estimated travel time from a pick up location to a drop-off location may take 3% to 8% longer relative to current estimates by the first dispatching service (e.g., due to a fleet-specific or a vehicle-specific characteristic such as a large loaded truck, or due to a driver-specific characteristic such as a slow driver), and that an estimated unloading time may take 400% longer relative to current estimates by the first dispatching service. Thus, by using the statistical model generated based on historical information, the first dispatching service can provide an ETA with improved accuracy. In some embodiments, the historical information from which the statistical model is generated includes information from trips dispatched by a second dispatching service that is different from the first dispatching service. In some embodiments, the historical information from which the statistical model is generated includes information from trips dispatched by the first dispatching service.

For example, the ETA (e.g., estimated t3′) provided in FIG. 3B for vehicle 110-1 of the fleet 120 can be updated using the statistical model generated based on historical information to more accurately reflect the actual arrival time. Based on the information shown in FIG. 3C that reflects the change in ETA due to the statistical model, the ETA for the trip shown in FIG. 3B can be updated from 4:52 pm to take into consideration the statistical model generated based on historical information.

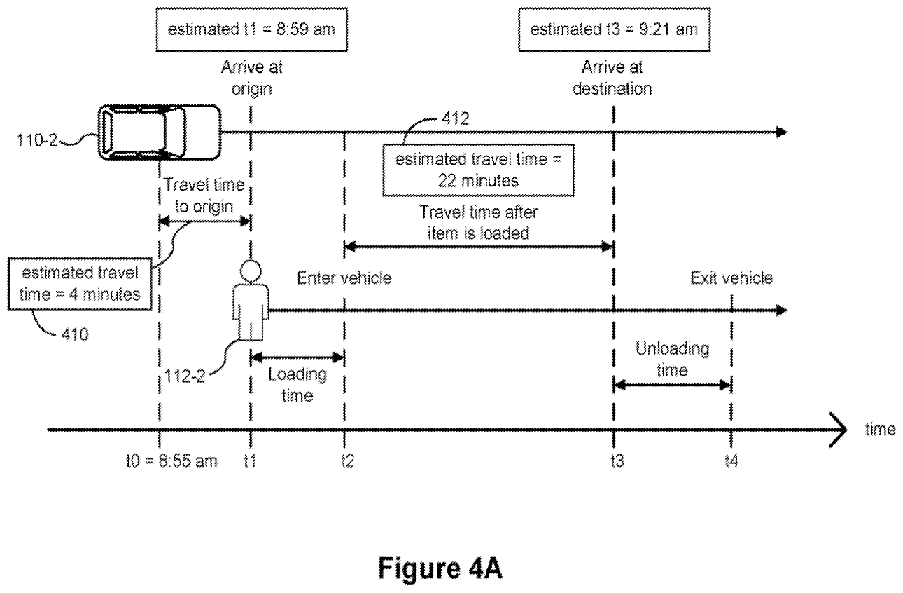

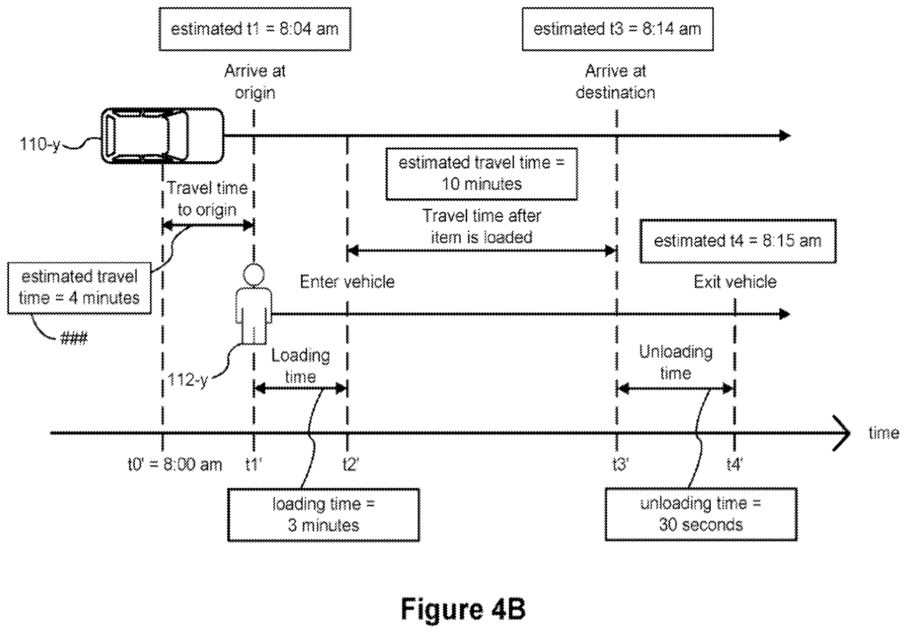

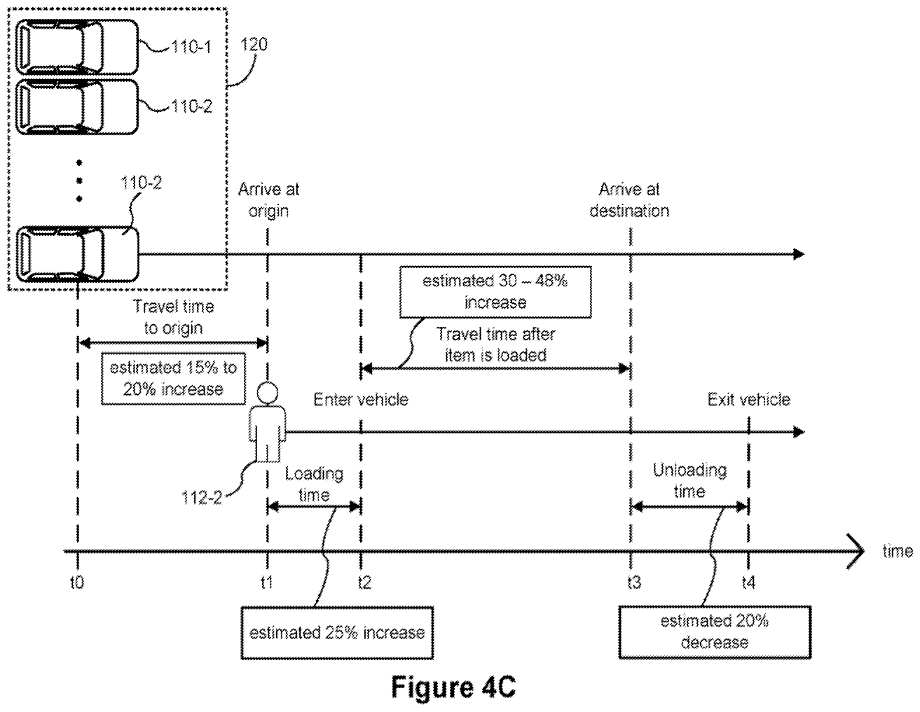

FIGS. 4A-4C illustrate another example of generating an estimated time of arrival for a trip based on historical information, in accordance with some embodiments,

FIG. 4A represents a timeline for a trip request that is received from a user. A first dispatching service dispatches vehicle 110-2 of a fleet 120 of vehicles to complete the trip. The vehicle 110-2 is dispatched at t0=8:55 am and the first dispatching service estimates a travel time 410 of 4 minutes and that the vehicle 110-2 will arrive at the origin at an estimated time t1 of 8:59 am. The first dispatching service may also estimate a loading time to load passenger(s) 112-2 so that the vehicle 110-2 is predicted to depart from the origin (e.g., pick-up location) at a time, t2, that is later than time t1. The first dispatching service estimates a travel time 412 of 22 minutes and predicts that the vehicle 110-2 will arrive at the destination (e.g., drop-off location) at ETA t3 of 9:21 am to drop off the passenger(s) 112-2. The first dispatching service may also estimate an unloading time so that the trip is considered to be completed at a time, t4, that is later than the ETA, t3.

FIG. 4B represents a timeline for a trip that has been completed by a vehicle of the fleet 120 of vehicles. The trip is one of the plurality of trips that are included in historical information used to generate a statistical model for providing updated ETAs to improve ETA prediction accuracy. Thus, the timeline shown in FIG. 4B is only one of a plurality of trips that are used to adjust or update the ETA, t3, provided in FIG. 4A. In some embodiments, the trip shown in FIG. 4B was dispatched by a second dispatching service that is different from the first dispatching service. In some embodiments, the trip shown in FIG. 4B was dispatched by the first dispatching service.

In this example, a vehicle 110-y of the fleet 120 of vehicles is dispatched at t0′=8:00 am to complete a requested trip. The vehicle 110-y takes 4 minutes to arrive at the origin, and arrives at the origin at t1′ of 8:04 am. It takes 3 minutes to load the passenger(s) 112-y and the vehicle departs the origin at time t2′. The vehicle 110-7 takes 10 minutes to travel to the destination, and arrives at the destination at t3′=8:14 am. The vehicle 110-y takes 30 seconds to unload the passenger(s) 112-y from the vehicle 110-y and the trip is completed at t4′=8:15 am.

Historical information for completed trips, such as the timeline for a completed trip shown in FIG. 4B, is used to generate a statistical model for improving ETA predictions. For example, the timeline shown in FIG. 4A may correspond to a trip request to transport one or more passengers during weekday morning rush hour. Thus, the historical information from which the statistical model is generated may consist of information for trips that were completed during morning rush hour on weekdays for transporting passengers. In another example, the historical information from which the statistical model is generated may consist of information for trips that were completed by a specific driver who is driving the vehicle dispatched for the trip shown in FIG. 4C.

In some embodiments, the historical information from which the statistical model is generated includes information from trips that were dispatched by a second dispatching service that is different from the first dispatching service. In some embodiments, the historical information from which the statistical model is generated includes information from trips that were dispatched by the first dispatching service.

FIG. 4C represents an updated timeline for a plurality of trip requests that are to be completed by the fleet 120 of vehicles (e.g., the fleet of delivery vans). The first dispatching service utilizes one or more statistical models generated using historical information regarding completed trips (such as the historical information pertaining to the completed trip shown in FIG. 4C) to provide ETAs with improved accuracy. For example, while travel time may vary due to varying travel distances (e.g., distances between an origin and a destination and/or distances between current vehicle location and origin) for each trip, a statistical model allows the first dispatching service to take into account a difference in loading times during weekday mornings compared to loading times during evenings or weekends. In another example, a statistical model may allow the first dispatching service to take into account a difference in loading times for suburban areas compared to urban areas or compared to the average loading time. Thus, a statistical model can be used by the first dispatching service to improve ETA predictions. For example, a statistical model may include an indication that an estimated travel time from a current vehicle position to a pick up location may take 15% to 20% longer relative to current estimates by the first dispatching service (e.g., based on historical information indicating that the driver of the vehicle has travel times that are typically slower than estimated travel times), an indication that an estimated loading time may take 25% longer relative to current estimates by the first dispatching service (for example, if the first dispatching service is currently using average loading times across all trips). A statistical model may also include an indication that an estimated travel time from a pick up location to a drop-off location may take 30% to 48% longer relative to current estimates by the first dispatching service, and that an estimated unloading time may take 20% shorter (e.g., be 20% faster) relative to current estimates by the first dispatching service. Thus, by using a statistical model generated based on historical information regarding completed trips, the first dispatching service can provide an ETA with improved accuracy.

A statistical model is able to provide the first dispatching service with an adjustment factor (e.g., correction factor) that accounts for fleet-specific features (e.g., characteristics), vehicle-specific features (e.g., characteristics), trip-specific features (e.g., characteristics), and/or driver-specific features (e.g., characteristics) that may affect (e.g., change) the ETA for a trip. Thus, the first dispatching service may generate one or more statistical models that can be used when providing ETAs for trip requests for a fleet. For example, when the statistical model is generated based on historical information corresponding to trips that have been completed by any of the vehicles of the fleet and at any time, the first dispatching service may utilize the same statistical model to improve ETA prediction for all new trips (e.g., trip requests) for the fleet in another example, when a first statistical model is generated based on historical information corresponding to trips that have been completed by a first driver of the fleet and a second statistical model, different from the first statistical model, is generated based on historical information corresponding to trips that have been completed by a second driver of the fleet that is a different driver from the first driver, the first dispatching service may utilize the first statistical model to improve ETA prediction for all new trips (e.g., trip requests) that are assigned to the first driver and use the second statistical model to improve ETA prediction for all new trips (e.g., trip requests) that are assigned to the second driver. Thus, while the first dispatching service may utilize any number (e.g., one or more) of statistical models as deemed appropriate (e.g., relevant) to improve ETA prediction for the entire fleet of vehicles, the ETA provided for a trip of the fleet may be determined based at least in part on a different statistical model than a statistical model upon which an ETA provided for another trip of the same fleet is based.

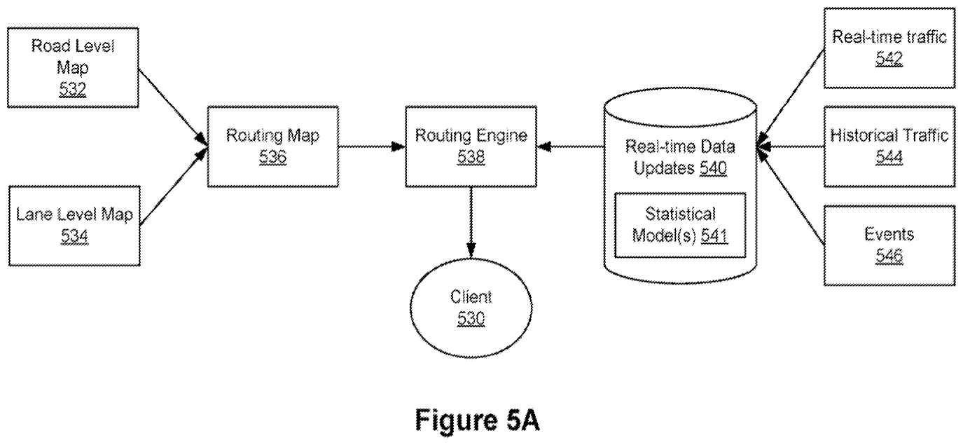

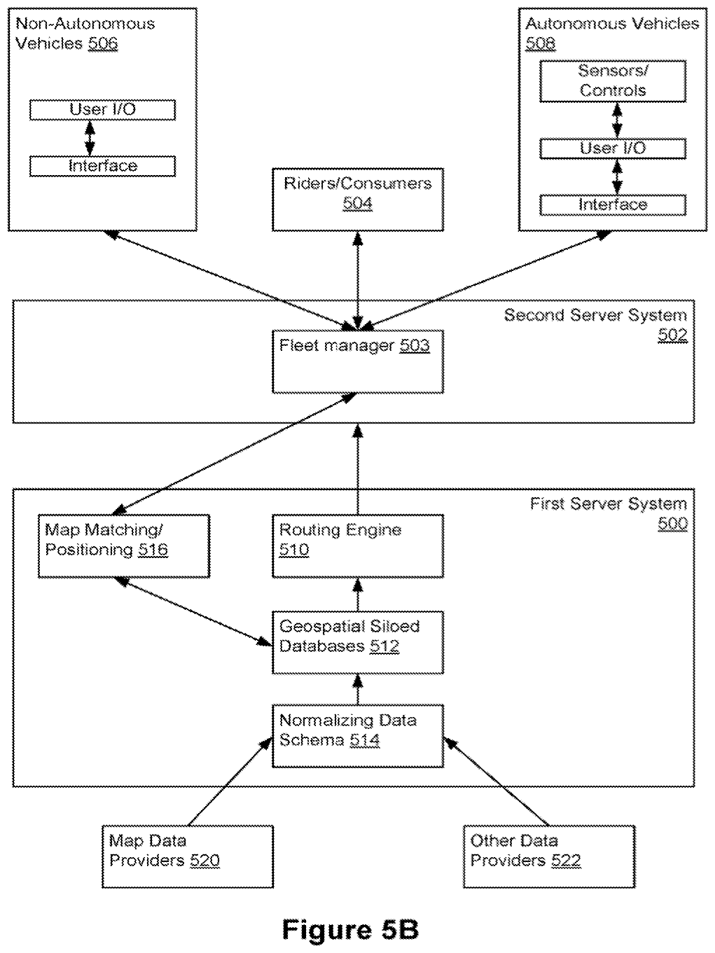

FIGS. 5A-5B are block diagrams illustrating an architecture of a vehicle routing engine, in accordance with some embodiments. For example, the client 530 is the vehicle to be routed, such as a non-autonomous vehicle or an autonomous vehicle (or an electronic device associated with the autonomous vehicle).

Real-time data updates 540 include a server system that receives and/or tracks real-time traffic 542, historical traffic 544, and events 546, and includes statistical model(s) 541, and processes and forwards the information to routing engine 538, such that routing engine 538 can create and/or update an ETA for client 530. In some embodiments, the routing engine 538 also uses the information to create and/or update a route for client 530. The routing engine 538 also uses information received from routing map 536 (which may include information from a road level map 532 and/or a lane level map 534) to create/update the route for client 530.

FIG. 5B illustrates exemplary architecture (e.g., a so-called “stack”) for a fleet of vehicles. The features of the exemplary architecture shown in FIG. 5B may optionally complement, replace, or be combined with the features of the architecture described with respect to FIG. 5A. In some embodiments, the fleet of vehicles is a mixed fleet of vehicles including autonomous vehicles (e.g., autonomous vehicles 508) and non-autonomous vehicles (e.g., non-autonomous vehicles 506). In some circumstances, a fleet includes a mix of different vehicle types (e.g., automobiles, bicycles, scooters, and/or delivery robots). In some circumstances, the fleet provides services to riders (e.g., riders/consumers 504) by transporting riders from a first location to a second location. In some circumstances, the fleet provides services to other consumers. e.g., by delivering items to the consumers (e.g., delivering meals from restaurants, delivering packages from retail stores).

To facilitate the provision of these services using a mixed fleet of vehicles, the stack includes a first server system 500 that provides fleet management services and routing information. The first server system 500 includes one or more processors (e.g., CPUs) and memory storing instructions for the modules described with reference to the first server system (e.g., the map matching/positioning module 516, the routing engine 510, the geospatial siloed databases 512, and the normalizing data schema 514). The first server system 500 interfaces with a fleet manager 503 on a second server system 502. In the exemplary architecture shown in the figure, the second server system 502 acts as a client of the first server system 500, while riders, consumers (e.g., riders/consumers 504), and vehicles (e.g., non-autonomous vehicles 506 and/or autonomous vehicles 508) act as clients of the second server system 502.

In some embodiments, the second server system 502 is a separate and distinct server system from the first server system 500. The second server system 502 includes one or more processors (e.g., CPUs) and memory storing instructions for the modules described with reference to the second server system 502 (e.g., the fleet manager 503). The instructions are executed by the one or more processors. In some circumstances, the fleet manager 503 is one of a plurality of fleet managers serviced by the first server system 500. For example, the fleet manager 503 may be a fleet manager for a specific company's fleet, and the first server system 500 may provide services to multiple companies' fleets.

The first server system 500 includes a muting engine 510 that provides routes, distances, and ETAs for autonomous vehicles 508 and non-autonomous vehicles 506. In some embodiments, a different instance of the routing engine is instantiated for each fleet.

The first server system includes one or more geospatial siloed databases 512 storing geospatial data (e.g., data stored with a corresponding geographical location, such as latitude and longitude). The geospatial siloed databases 512 include map data received from map data providers 520 (e.g., data such as streets locations/geometries, street names). An example of a Map Data Provider is OpenStreetMap. In some embodiments, the geospatial data further includes “high definition” data such as lane-level data (e.g., lane locations/geometries, information about which maneuvers are permitted from which lanes) received from the map data providers 520. The geospatial data further includes data from other data providers 522, such as information received from municipalities about construction and road closures, real-time data, traffic data and other data. In addition, the geospatial siloed databases 512 store locations (e.g., map matched locations) of the vehicles in the various fleets.

In some embodiments, the geospatial siloed databases 512 store a plurality of distinct instances of data covering the same geographical region. For example, the geospatial siloed databases 512 store multiple maps (e.g., with geospatial data overlaid on those maps) covering the same region. In some circumstances, the different maps will include data appropriate to a specific fleet's vehicles (e.g., a fleet will include autonomous vehicles and delivery bots, and the geospatial siloed databases 512 will store one or more maps with information appropriate to the fleet's vehicle types). Some instances of the map may be public to any client (e.g., any fleet manager), while other versions of the map may be private to certain clients (e.g., certain fleet managers). For example, a respective fleet may license data from a respective HD map data provider. The data provided by the respective HD map data provider are thus siloed and private to the respective fleet's fleet manager (e.g., fleet manager 503).

The first server system 500 further includes a map matching/positioning module 516 that matches location data received from vehicles to a map location (e.g., a location of a map stored in the geospatial siloed databases 512). For example, some vehicles generate location data (e.g., GPS data or data from another positioning system, such as GLONASS, Galileo, or BeiDou). In some circumstances, this data is noisy and may place the vehicle away from its actual location, e.g., on a sidewalk or in a building. The map matching/positioning module 516 receives the location data from a respective vehicle (e.g., through the fleet manager 503, which interfaces with the first server system 500), matches the noisy location data to a probable road location and/or lane location and updates the “map matched” location of the vehicle in the geospatial siloed databases 512 (e.g., updates the matched position). In addition, the map matched position is provided to the fleet manager 503 for various purposes (e.g., monitoring the fleet).

As noted above, the stack includes a second server system 502, optionally distinct and separate from the first server system 500. The second server system 360 includes the fleet manager 503, which acts as a client of the first server system 350 (e.g., a client of the routing engine). The fleet manager 503 dispatches vehicles (e.g., non-autonomous vehicles 506 and/or autonomous vehicles 508), assigns routes to vehicles, and assigns staging locations to vehicles within its corresponding fleet (e.g., using information and routes provided by the routing engine). In addition, the fleet manager 503 interfaces with riders/consumers 504 (e.g., via a mobile application on the rider's smartphone or other device). The fleet manager 503 provides information such as ETAs and trip costs to the riders/consumers 504 via their mobile devices. In some embodiments, the fleet manager 503 also receives data such as vehicle positions (e.g., location, including optionally lane-specific location and orientation (e.g., which way the vehicle is pointing)) from the individual vehicles.

In some embodiments, an autonomous vehicle includes an AV platform which serves as an operating system and framework for the autonomous functionality of the autonomous vehicle. The autonomous vehicle includes one or more processors (e.g., CPUs) and memory storing instructions for the modules described with reference to the autonomous vehicle (e.g., the interface module, the AV platform, drivers for the sensors/controls). The instructions are executed by the one or more processors. An example of an AV platform is the open source Robotics Operating System. The fleet manager (e.g., fleet manager 503) interacts with the autonomous vehicles (e.g., autonomous vehicles 508) through an interface module, which is a module that runs on the AV platform to provide routes to the AV platform and receive data from the autonomous vehicle's sensors. For example, in some circumstances, the interface module is provided by the developer of the routing engine to act as a liaison between the first server system and the robotics of the autonomous vehicle. The AV platform receives sensor data from the autonomous vehicles sensor's and, in some circumstances, makes the sensor data available to the fleet manager, which can make the sensor data available further down the stack, for example, to the map matching/position module. In some embodiments, the AV platform sends commands to the autonomous vehicle's controls (e.g., acceleration commands, breaking commands, turning commands, etc.) through a drive-by-wire system.

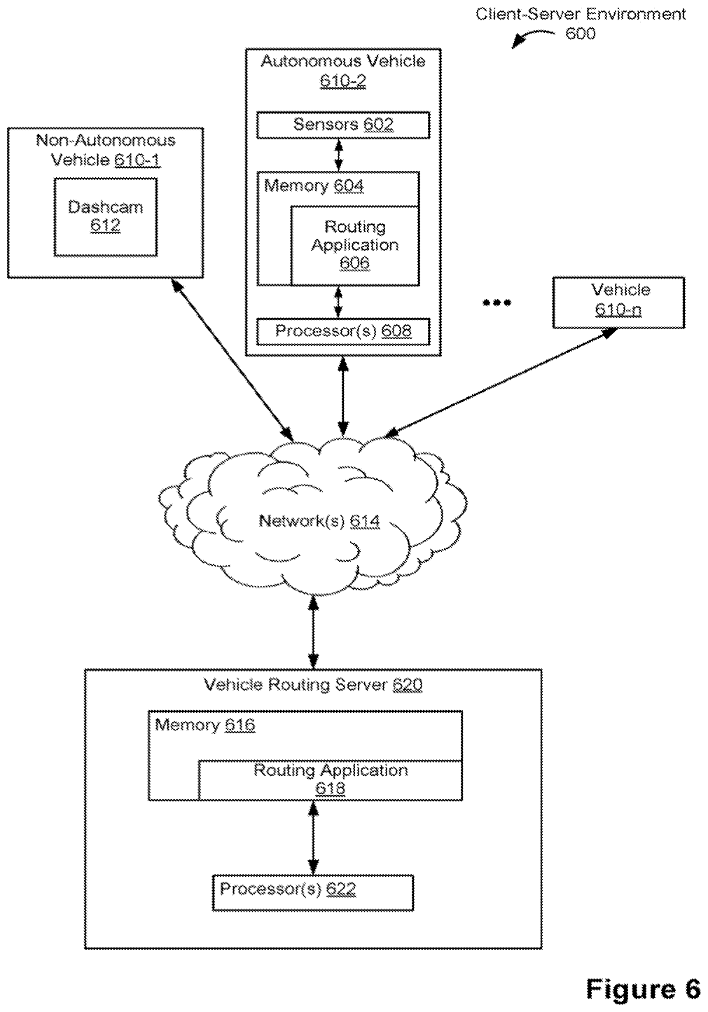

FIG. 6 is a block diagram illustrating a client-server environment, in accordance with some embodiments. The client-server environment 600 includes vehicles 610 (e.g., 610-1, 610-2, . . . , 610-n) that are connected to a vehicle routing server 620 through one or more networks 614. In some embodiments, vehicles 610 are or are analogous to vehicles 506 or 508 (shown in FIG. 5B). In some circumstances, the vehicles 610 operate as clients of vehicle routing server 620. The one or more networks 614 can be any network (or combination of networks) such as the Internet, other Wide Area Networks, Local Area Networks, metropolitan area networks. VPNs, peer-to-peer, ad-hoc connections, and so on.

The non-autonomous vehicle 610-1 is a representative human-driven vehicle (e.g., a car, truck, or motorcycle). In some embodiments, non-autonomous vehicle 610-1 is or is analogous to non-autonomous vehicle 506 (FIG. 5B) In some embodiments, non-autonomous vehicle 610-1 includes a dashboard camera 612 (e.g., dashcam 612) that acquires and sends camera images to vehicle routing server 620, which can automatically identify road conditions from dashboard camera images (as well as from autonomous vehicle camera sensor data from autonomous vehicles, such as from sensors 602 in an autonomous vehicle).

The autonomous vehicle 610-2 (e.g., a car, truck, or motorcycle) includes non-transitory memory 604 (e.g., non-volatile memory) that stores instructions for one or more client routing applications 606. In some embodiments, autonomous vehicle 610-2 is or is analogous to autonomous vehicle 508 (FIG. 5B) Client routing applications 606 are executed by one or more processors (e.g., CPUs) 608 on the autonomous vehicle 610-2. In some embodiments, the client routing applications 606 send requests for routes to the vehicle routing server 620 and receive selected routes from the vehicle routing server 620. In some embodiments, the client routing applications 606 direct the autonomous vehicles 610-2 along the selected routes. Client routing applications 606 may be embodied as any appropriate combination of programs, firmware, operating systems, or other logical or physical aspects of the autonomous vehicle 610-2. Autonomous vehicle 610-2 also optionally includes one or more network interfaces and one or more communication buses for interconnecting these components. Autonomous vehicle 610-2 further includes vehicle components, such as an engine/motor, a steering mechanism, lights, signaling mechanisms, etc., some or all of which may be under the control of programs (e.g., a client routing application 606) stored in memory 604.

In some circumstances, a fleet of vehicles e.g., up to vehicle 610-n) is in communication with vehicle routing server 620. The fleet may be a mix of autonomous and human driven vehicles or may be entirely autonomous.

Vehicle routing server 620 includes non-transitory memory 616 (e.g., non-volatile memory) that stores instructions for one or more server routing applications 618 (sometimes referred to as “routing engines”). Vehicle routing server 620 further includes one or more processors (e.g., CPUs) 622 for executing server routing applications 618. Server routing applications 418 may be embodied as any appropriate combination of programs, firmware, operating systems, or other logical or physical aspects of the autonomous vehicle 610-2. Vehicle routing server 620 also optionally includes one or more network interfaces and one or more communication buses for interconnecting these components.

The above-identified applications correspond to sets of instructions for performing functions described herein. The applications need not be implemented as separate software programs, procedures, or modules, and thus various subsets of these instructions may be combined or otherwise re-arranged in various embodiments.

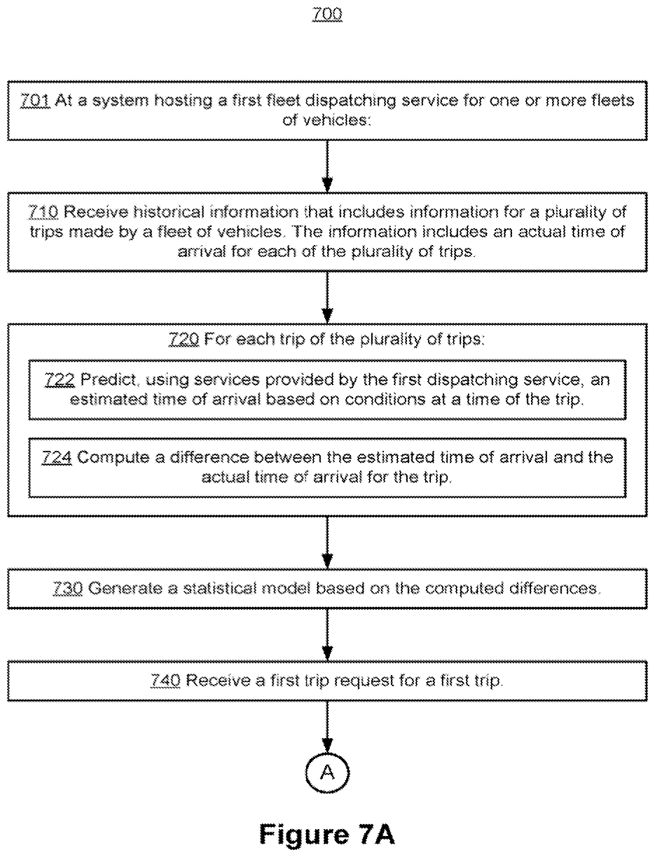

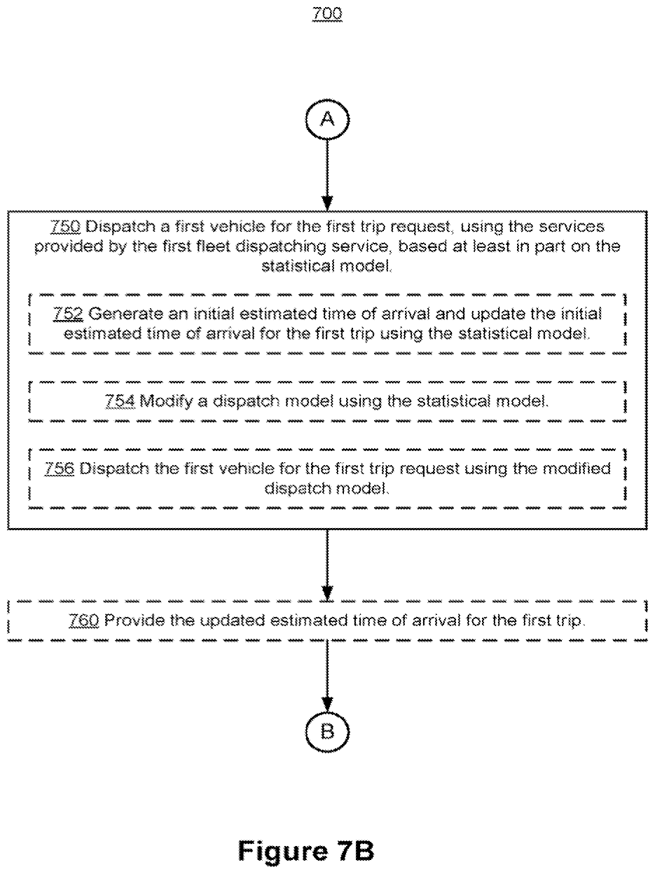

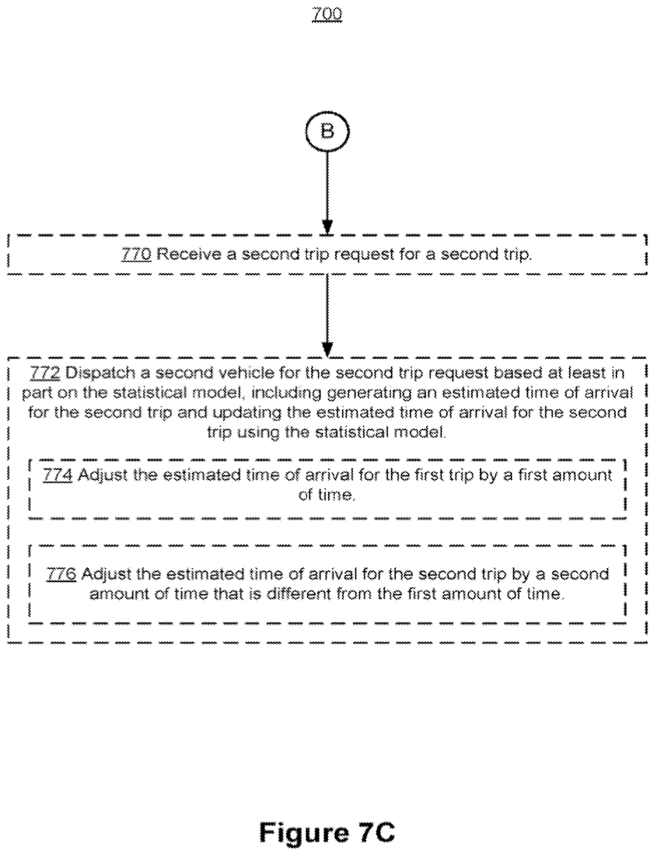

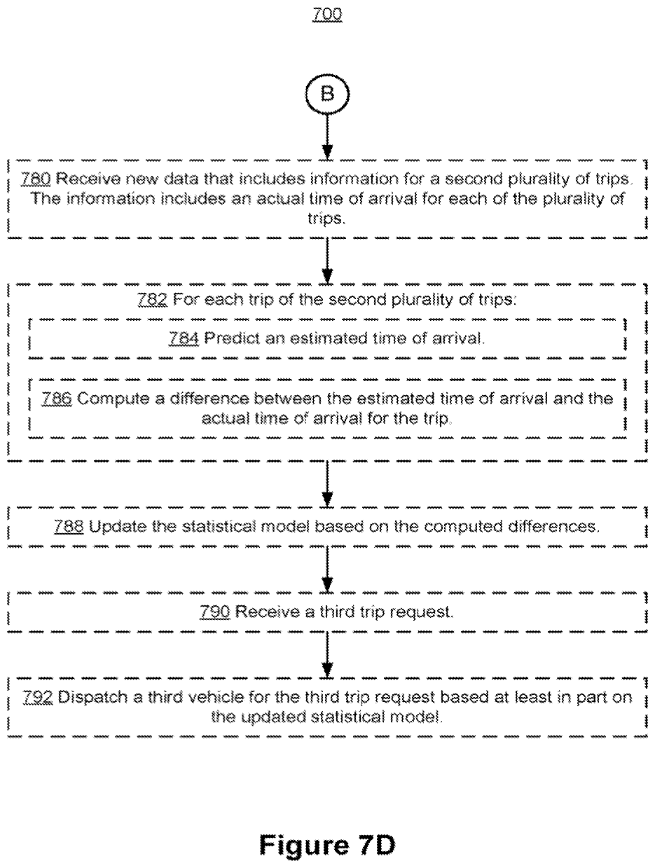

FIGS. 7A-7D illustrate a flowchart of a method 700 for predicting estimated times of arrival (ETAs) based on historical information, in accordance with some embodiments. The method 700 is performed (701) at a system hosting a first fleet dispatching service for one or more fleets (e.g., fleets 120) of vehicles. The method 700 includes receiving (710) historical information that includes information for a plurality of trips made by a fleet 120 of vehicles. The information includes an actual time of arrival for each of the plurality of trips. The method 700 also includes, for each trip of the plurality of trips (720), predicting (722) an ETA based on conditions at a time of the trip using services provided by the first dispatching service, and computing (724) a difference between the ETA and the actual time of arrival for the trip. The method 700 further includes generating (730) a statistical model based on the computed differences and receiving (740) a first trip request for a first trip. The method 700 also includes dispatching (750), using the services provided by the first fleet dispatching service, a first vehicle for the first trip request based at least in part on the statistical model.

In some embodiments, the historical information is an event log. The event log includes, for each trip of the plurality of trips: a pick-up location, a drop-off location, and a time of the trip. FIG. 2B illustrates an example of an event log 220.

In some embodiments, the information for the plurality of trips were dispatched by a second fleet dispatching service that is different from the first fleet dispatching service. For example, when a first dispatching service starts providing a dispatching service for a fleet of vehicles, the first dispatching service may utilize historical information regarding trips completed by the fleet of vehicles that were dispatched by the second dispatching service to improve ETA prediction for the fleet of vehicles. By doing so, the first dispatching service can provide accurate ETAs for the fleet of vehicles starting from the very first trip for the fleet that is dispatched by the first dispatching service.

In some embodiments, the information for the plurality of trips were dispatched by the first fleet dispatching service. For example, the first fleet dispatching service may periodically use historical information to generate one or more new statistical models so that ETA prediction remains up to date with any changes to the fleet, such as the introduction of new drivers or changing operational constraints (e.g., routing constraints).

In some embodiments, the conditions at the time of the trip include a state of the road network at the time of the trip (e.g., map of roads, road closures, weather condition, road condition), traffic at the time of the trip, and user-defined constraints for the fleet of vehicles at the time of the trip (e.g., operational region, prohibited maneuvers, prohibited roads, prohibited areas). In some embodiments, these same conditions are logged (e.g., stored) in real-time, allowing the conditions to be recreated when retrospectively simulating ETAs, as described herein.

In some embodiments, the statistical model is a linear regression that is generated based on the computed differences. For example, the linear regression provides a linear relationship between predicted estimated times of arrival and actual estimated times of arrival. An improved ETA prediction can thus be obtained by determining an initial ETA and updating the initial ETA using the linear regression.

In some embodiments, dispatching (750) the first vehicle for the first trip request includes generating (752) an ETA and updating the ETA for the first trip using the statistical model. For example, a routing engine generates an ETA (e.g., an initial ETA) that is determined based at least in part on (e.g., accounts for) current conditions, such as travel distance and current traffic conditions. The routing engine utilizes the ETA and updates the generated ETA using the statistical model. The statistical model provides an adjustment factor (e.g., correction factor) that takes into account any fleet-specific features, trip-specific features, vehicle-specific features, or driver specific features that may affect the ETA of the trip. The method 700 also includes modifying (754) a dispatch model using the statistical model, and dispatching (756) the first vehicle for the first trip request using the modified dispatch model. The method 700 also includes providing (760) the updated ETA for the first trip.

In some embodiments, the dispatched vehicle is a vehicle of the fleet of vehicles (e.g., the dispatched vehicle belongs to the fleet of vehicles, the dispatched vehicle is a vehicle 110-x of the fleet 120).

In some embodiments, the second plurality of trips were dispatched by the first fleet dispatching service.

In some embodiments, the method 700 further includes receiving (770) a second trip request for a second trip and dispatching (772) a second vehicle for the second trip request based at least in part on the statistical model, including generating an ETA for the second trip and updating the ETA for the second trip using the statistical model.

In some embodiments, updating the ETA for the first trip using the statistical model includes adjusting (774) the ETA for the first trip by a first amount of time. In some embodiments, the first amount of time is determined based on one or more of: a driver of the first vehicle, a vehicle type of the first vehicle, and the fleet to which the first vehicle belongs.

In some embodiments, updating the ETA for the second trip using the statistical model includes adjusting (776) the ETA for the second trip by a second amount of time that is different from the first amount of time.

In some embodiments, the method 700 also includes receiving (780) new data that includes information for a second plurality of trips. The information includes an actual time of arrival for each of the plurality of trips. In some embodiments, the method 700 also includes, for each trip of a second plurality of trips (782): predicting (784) an ETA computing (786) a difference between the ETA and the actual time of arrival for the trip. The method 700 further includes updating (788) the statistical model based on the computed differences, receiving (790) a third trip request, and dispatching (792) a third vehicle for the third trip request based at least in part on the updated statistical model.

In some embodiments, the second plurality of trips were dispatched by the first fleet dispatching service.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” is, optionally, construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative embodiments. For purposes of explanation, numerous specific details were set forth in order to provide an understanding of various embodiments of the inventive subject matter. It will be evident, however, to those skilled in the art that embodiments of the subject matter are, optionally, practiced without these specific details. In general, well-known instruction instances, protocols, structures and techniques have not been shown in detail.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best use the embodiments and various embodiments with various modifications as are suited to the particular use contemplated.

1. A method comprising:
at a system hosting a first fleet dispatching service for one or more fleets of vehicles:
receiving historical information that includes information for a plurality of trips made by a fleet of vehicles, wherein the information includes an actual time of arrival for each of the plurality of trips;
for each trip of the plurality of trips:
predicting, using services provided by the first fleet dispatching service, an estimated time of arrival based on conditions at a time of the trip; and
computing a difference between the estimated time of arrival and the actual time of arrival for the trip;
generating a statistical model based on the computed differences;
receiving a first trip request for a first trip; and
dispatching a first vehicle for the first trip request, using the services provided by the first fleet dispatching service, based at least in part on the statistical model.

2. The method of claim 1, wherein:
dispatching the first vehicle for the first trip request based at least in part on the statistical model includes generating an estimated time of arrival for the first trip and updating the estimated time of arrival for the first trip using the statistical model; and
the method further comprises:
providing the updated estimated time of arrival for the first trip.

3. The method of claim 2, further comprising:
receiving a second trip request for a second trip; and
dispatching a second vehicle for the second trip request based at least in part on the statistical model, including generating an estimated time of arrival for the second trip and updating the estimated time of arrival for the second trip using the statistical model, wherein:
updating the estimated time of arrival for the first trip using the statistical model includes adjusting the estimated time of arrival for the first trip by a first amount of time; and
updating the estimated time of arrival for the second trip using the statistical model includes adjusting the estimated time of arrival for the second trip by a second amount of time that is different from the first amount of time.

4. The method of claim 2, wherein:
updating the estimated time of arrival for the first trip using the statistical model includes adjusting the estimated time of arrival for the first trip by a first amount of time; and
the first amount of time is determined based on one or more of: a driver of the first vehicle, a vehicle type of the first vehicle, and the fleet to which the first vehicle belongs.

5. The method of claim 1, wherein dispatching the first vehicle for the first trip request based at least in part on the statistical model includes:
modifying a dispatch model using the statistical model; and
dispatching the first vehicle for the first trip request using the modified dispatch model.

6. The method of claim 1, wherein:
the historical information is an event log; and
the event log includes, for each trip of the plurality of trips: a pick-up location, a drop-off location, and a time of trip.

7. The method of claim 1, wherein the conditions at the time of the trip include:
a state of the road network at the time of the trip;
traffic at the time of the trip; and
user-defined constraints for the fleet of vehicles at the time of the trip.

8. The method of claim 1, wherein the plurality of trips were dispatched by a second fleet dispatching service that is different from the first fleet dispatching service.

9. The method of claim 1, the method further comprising:
receiving new data that includes information for a second plurality of trips, the information including an actual time of arrival for each of the second plurality of trips;
for each trip of the second plurality of trips:
predicting an estimated time of arrival; and
computing a difference between the estimated time of arrival and the actual time of arrival for the trip;
updating the statistical model based on the computed differences;
receiving a third trip request; and
dispatching a third vehicle for the third trip request based at least in part on the updated statistical model.

10. The method of claim 9, wherein the second plurality of trips were dispatched by the first fleet dispatching service.

11. The method of claim 1, wherein the dispatched vehicle is a vehicle of the fleet of vehicles.

12. The method of claim 1, wherein the statistical model is a linear regression generated based on the computed differences.

13-14. (canceled)

15. A computer system, comprising:
one or more processors; and
memory storing instructions that, when executed by the one or more processors, cause the one or more processors to:
receive historical information that includes information for a plurality of trips made by a fleet of vehicles, wherein the information includes an actual time of arrival for each of the plurality of trips;
for each trip of the plurality of trips:
predict, using services provided by the first fleet dispatching service, an estimated time of arrival based on conditions at a time of the trip; and
compute a difference between the estimated time of arrival and the actual time of arrival for the trip;
generate a statistical model based on the computed differences;
receive a first trip request for a first trip; and
dispatch a first vehicle for the first trip request, using the services provided by the first fleet dispatching service, based at least in part on the statistical model.

16. The computer system of claim 1, wherein:
dispatching the first vehicle for the first trip request based at least in part on the statistical model includes generating an estimated time of arrival for the first trip and updating the estimated time of arrival for the first trip using the statistical model; and
wherein the instructions further cause the one or more processors to provide the updated estimated time of arrival for the first trip.

17. The computer system of claim 16, wherein the instructions further cause the one or more processors to:
receive a second trip request for a second trip; and
dispatch a second vehicle for the second trip request based at least in part on the statistical model, including generating an estimated time of arrival for the second trip and updating the estimated time of arrival for the second trip using the statistical model, wherein:
updating the estimated time of arrival for the first trip using the statistical model includes adjusting the estimated time of arrival for the first trip by a first amount of time; and
updating the estimated time of arrival for the second trip using the statistical model includes adjusting the estimated time of arrival for the second trip by a second amount of time that is different from the first amount of time.

18. The computer system of claim 16, wherein:
updating the estimated time of arrival for the first trip using the statistical model includes adjusting the estimated time of arrival for the first trip by a first amount of time; and
the first amount of time is determined based on one or more of: a driver of the first vehicle, a vehicle type of the first vehicle, and the fleet to which the first vehicle belongs.

19. The computer system of claim 15, wherein dispatching the first vehicle for the first trip request based at least in part on the statistical model includes:
modifying a dispatch model using the statistical model; and
dispatching the first vehicle for the first trip request using the modified dispatch model.

20. The computer system of claim 15, wherein the instructions further cause the one or more processors to:
receive new data that includes information for a second plurality of trips, the information including an actual time of arrival for each of the second plurality of trips;
for each trip of the second plurality of trips:
predict an estimated time of arrival; and
compute a difference between the estimated time of arrival and the actual time of arrival for the trip;
update the statistical model based on the computed differences;
receive a third trip request; and
dispatch a third vehicle for the third trip request based at least in part on the updated statistical model.

21. A non-transitory computer readable storage medium storing instructions that, when executed by a computer system having one or more processors, cause the one or more processors to:
receive historical information that includes information for a plurality of trips made by a fleet of vehicles, wherein the information includes an actual time of arrival for each of the plurality of trips;
for each trip of the plurality of trips:
predict, using services provided by the first fleet dispatching service, an estimated time of arrival based on conditions at a time of the trip; and
compute a difference between the estimated time of arrival and the actual time of arrival for the trip;
generate a statistical model based on the computed differences;
receive a first trip request for a first trip; and
dispatch a first vehicle for the first trip request, using the services provided by the first fleet dispatching service, based at least in part on the statistical model.

22. The non-transitory computer readable storage medium of claim 21, wherein the instructions cause the one or more processors to:
receive new data that includes information for a second plurality of trips, the information including an actual time of arrival for each of the second plurality of trips;
for each trip of the second plurality of trips:
predict an estimated time of arrival; and
compute a difference between the estimated time of arrival and the actual time of arrival for the trip;
update the statistical model based on the computed differences;
receive a third trip request; and
dispatch a third vehicle for the third trip request based at least in part on the updated statistical model.
